(19) United States
(12) Patent Application Publication
(10) Pub. No.: US 2023/0406780 A1
(43) Pub. Date: Dec. 21, 2023

(54) METHOD FOR FABRICATING A TURBOMACHINE BLADE MADE FROM A COMPOSITE MATERIAL

(71) Applicant: SAFRAN CERAMICS, Le Haillan (FR)

(72) Inventor: Eric CONETE, Moissy-Cramayel (FR)

(73) Assignee: SAFRAN CERAMICS, Le Haillan (FR)

(21) Appl. No.: 18/250,275

(22) PCT Filed: Oct. 27, 2021
(86) PCT No.: PCT/FR2021/051884

§ 371 Date: Apr. 24, 2023

(30) Foreign Application Priority Data
Oct. 27, 2020 (FR) FR2010984

(51) Int. Cl. C04B 35/80; F01D 5/28

(52) U.S. Cl. CPC C04B 35/80; F01D 5/282; C04B 2235/5256; C04B 2235/612; F05D 2230/10; F05D 2300/6033

(57) ABSTRACT

Method for manufacturing a turbomachine blade made of ceramic-matrix composite material comprising an airfoil and a platform, producing a first fibrous preform, the first fibrous preform forming an airfoil preform, producing a second fibrous preform comprising a housing, the second fibrous preform forming a platform preform, producing a strand of ceramic fibers, consolidating the fibrous preforms and the strand of ceramic fibers to form consolidated preforms and a consolidated strand, assembling the consolidated preforms by engagement and cooperation of the first consolidated preform in the housing, the consolidated strand being interposed between the first consolidated preform and the second consolidated perform, co-densifying the assembly to form the turbomachine blade.

### TECHNICAL FIELD

The present disclosure relates to a method for manufacturing a turbomachine blade made of composite material, particularly for an aeronautical engine.

### PRIOR ART

It is known to implement, in the turbomachines, movable blades formed of a metal material. It is desirable to replace these metal-material blades with blades formed of a composite material in order to reduce the mass of the turbomachines. Such a replacement is all the more advantageous since some composite materials such as the ceramic-matrix composite materials are compatible with an exposure to an increased operating temperature, thus making it possible to improve the performance of the engine.

Document WO2014/076408 is known, which describes a fibrous preform for a turbomachine blade obtained by an integral three-dimensional weaving. However, the three-dimensional weaving may be a complex method.

Moreover, the nozzle is subjected to forces related to the aerodynamic stream in the flowpath and to the piston effect on the casing under the nozzle due to the pressure difference between the upstream and downstream cavities under the nozzle. These forces can create a moment around the attachment between the nozzle and the casing and therefore reduce the mechanical properties of the turbomachine.

There is therefore a need to have new methods for simply manufacturing a turbomachine blade made of composite material having the desired mechanical and thermal properties while having relatively complex shapes.

### DISCLOSURE OF THE INVENTION

The present disclosure aims to overcome at least partly these drawbacks.

The present disclosure relates to a method for manufacturing a turbomachine blade made of ceramic-matrix composite material comprising an airfoil and a platform, the method comprising:
the production of a first fibrous preform comprising ceramic fibers, the first fibrous preform forming an airfoil preform;
the production of a second fibrous preform comprising ceramic fibers, the second fibrous preform comprising a housing, the second fibrous preform forming a platform preform;
the production of a strand of ceramic fibers;
the consolidation of the first fibrous preform in one piece, of the second fibrous preform in one piece and of the strand of ceramic fibers to form a first consolidated preform, a second consolidated preform comprising a housing and a consolidated strand;
the assembly of the first consolidated preform and of the second consolidated preform, by engagement and cooperation of the first consolidated preform in the housing, the consolidated strand being interposed between the first consolidated preform and the second consolidated preform;
the co-densification of the assembly to form the turbomachine blade.

A preform is said to be in the consolidated state when it has undergone a consolidation step during which its initial porosity has been partially filled with a deposition of a consolidation phase, this preform in the consolidated state retaining a residual porosity which may be in whole or in part filled during the subsequent co-densification step. Various examples of consolidation methods are detailed below.

A preform is said to be in the unconsolidated state when it is devoid of such a consolidation phase. A preform in the unconsolidated state may be in the dry state or be impregnated with a precursor of a material of a consolidation phase, the consolidation not being in the latter case finalized due to the non-transformation of the precursor into a consolidation phase.

Thus, it is possible to manufacture separately a first and a second preform each supporting a limited number of functions so as to make them both easily formable and to assemble these two preforms in order to form the preform constituting the fibrous reinforcement of the blade to be manufactured. By separating the functions of the blade on two fibrous preforms, it becomes possible to simplify the textile definition of each of the first and second preforms as well as to facilitate their possible shaping.

Thus, compared to the case where the blade is manufactured from a fibrous preform in one piece, the blade manufacturing method is significantly simplified. Once the blade has been co-densified, the consolidated strand ensures the continuity of the mechanical and thermal loads from the platforms to the airfoil of the blade. In particular, after co-densification, the shear forces are transmitted from the first consolidated preform to the second consolidated preform thanks to the presence of the consolidated strand. Its mechanical resistance is improved which thus gives good mechanical properties to the manufactured blade so that the turbine blade forms a homogeneous system from the point of view of the material.

By way of non-limiting example, the strand of ceramic fibers may be obtained with twisted yarns or braided yarns.

It is understood that the second fibrous preform forming a platform preform may also form a preform of other parts of the blade connected to the platform, for example the stilt and/or the bulb of a movable blade and/or wipers.

The step of producing the first fibrous preform or the second fibrous preform may be followed by a step of shaping the fibrous preform.

The blade thus manufactured may be used in a turbine or in a turbomachine compressor.

Thanks to the method, it is possible to manufacture a turbomachine blade made of ceramic-matrix composite material making it possible to increase the performance of the propulsion systems by increasing the gas temperatures and reducing the cooling flow rates.

It is understood that it is possible to form within the framework of the method defined above a plurality of platforms as well as possibly low walls and spoilers. It is particularly possible to obtain after implementation of the method a turbomachine blade including a first platform located on the side of the blade base as well as a second platform disposed at the blade tip and forming a blade root. Thus, in some embodiments, the method may comprise the production of several second fibrous preforms. For example, a second fibrous preform forming a platform preform at the blade tip and a second fibrous preform forming a platform preform at the blade base.

In some embodiments, the consolidated strand may be disposed in a groove formed at least in one of the first consolidated preform or of the second consolidated preform.

In some embodiments, the groove may be at least partially machined.

Preferably, the machining of the groove is carried out for fibrous preforms having a thickness greater than or equal to 5 mm (millimeter).

In some embodiments, the groove may be at least partially formed during the step of producing the first fibrous preform and/or the second fibrous preform.

Preferably, the formation of the groove during the step of producing the fibrous preforms is carried out for fibrous preforms having a thickness of less than 5 mm.

It is understood that the groove may be machined in a consolidated preform (the first or the second one) and be formed during the step of producing the first or second fibrous preform.

In some embodiments, the second consolidated preform may comprise two channels for inserting the consolidated strand into the groove.

In some embodiments, the channels may open out onto an outer face of the second consolidated preform.

In the following description, the terms “inner” and “outer” are defined with respect to the stream flowpath in the turbomachine.

It is understood that the second consolidated preform comprises an inner face and an outer face, the inner face being intended to delimit a stream flowpath of the turbomachine and the outer face being the face opposite to the inner face.

The risks of disruption of the stream in the flowpath may thus be reduced.

In some embodiments, the channels may have an angle relative to the outer face greater than or equal to 1° and less than or equal to 20°.

This angle makes it possible to facilitate the introduction and the exiting of the strand in/from the channels.

In some embodiments, part of the consolidated strand may be removed before the co-densification step.

By way of non-limiting example, the parts of the consolidated strand that protrude from the outer face may be leveled off before the co-densification step.

In some embodiments, part of the consolidated strand may be removed after the co-densification step.

By way of non-limiting example, the parts of the consolidated strand that protrude from the outer face may be kept during the co-densification step to promote the capillary rise of an infiltration liquid during the co-densification step. After co-densification, these parts may be removed by machining.

In some embodiments, the second consolidated preform may comprise a part including an extra thickness, the part including the extra thickness delimiting the housing.

In some embodiments, the first fibrous preform comprises multilayer woven ceramic fibers, webs of ceramic fibers or unidirectional long ceramic fibers.

It is meant by “multilayer weaving” the weaving performed between a plurality of layers of warp yarns and a plurality of layers of weft yarns, possibly followed by a shaping step and also the braiding.

The steps of multilayer weaving of ceramic fibers may be followed by a step of shaping the fibrous preform.

The use of webs of ceramic fibers or of unidirectional long ceramic fibers eliminates the need for a weaving step.

In some embodiments, the second fibrous preform comprises multilayer woven ceramic fibers, webs of ceramic fibers, unidirectional long ceramic fibers or short ceramic fibers.

The use of webs of ceramic fibers or of unidirectional long ceramic fibers eliminates the need for a weaving step.

The use of short ceramic fibers makes it possible to overcome the associated limitations in terms of achievable geometry when using multilayer woven ceramic fibers, webs of ceramic fibers or unidirectional long ceramic fibers.

The short fibers may have a length comprised between 50 μm and 5,000 μm, for example between 50 μm and 1,000 μm, for example between 100 μm and 500 μm, for example substantially 250 μm. Unless otherwise stated, an “average” dimension designates the dimension given by the statistical particle size distribution to half of the population, called d₅₀.

In some embodiments, the ceramic fibers are silicon carbide fibers.

By way of non-limiting examples, the ceramic fibers used may be carbon or silicon carbide (SiC) fibers marketed under the name Nicalon™, Hi-Nicalon or Hi-Nicalon™ Type S by the Japanese company Nippon Carbon and having for example a count (number of filaments) of 0.5K (500 filaments).

By way of non-limiting examples, the first and second fibrous preforms may each include, in particular be formed of, carbon yarns. As a variant, the first fibrous preform may include, in particular be formed of, carbon yarns and the second fibrous preform may include, in particular be formed of, ceramic yarns such as silicon carbide yarns. As a further variant, the first and second fibrous preforms may each include, in particular be formed of, ceramic yarns such as silicon carbide yarns.

In some embodiments, the turbomachine blade is a turbomachine straightener.

In some embodiments, the turbomachine blade is a movable turbomachine blade.

In some embodiments, the turbomachine may be a turbojet engine.

In some embodiments, the consolidation may be carried out by deposition of a consolidation phase deposited by gas process or by liquid process.

In some embodiments, the co-densification may be carried out by a melt infiltration process.

For example, the molten composition for the infiltration may comprise silicon.

In some embodiments, the ceramic fibers may be coated with an interphase layer, such as an interphase layer made of boron nitride (BN) or pyrocarbon (PyC).

This interphase layer makes it possible to deflect the cracks in the ceramic matrix when using the part. The interphase layer has, for example, a thickness of 500 nm. The interphase layer may also be coated with a protective layer, for example with a layer of silicon carbide a few microns thick. This protective layer makes it possible to protect the interphase from the potential chemical attacks of the molten composition during the infiltration of the first preform and possibly of the second preform.

### BRIEF DESCRIPTION OF THE DRAWINGS

Other characteristics and advantages of the object of the present disclosure will emerge from the following description of embodiments, given by way of non-limiting examples, with reference to the appended figures.

FIG. 1 is a schematic view in longitudinal section of a turbomachine.

FIG. 2 is a perspective view of a straightener portion of a high-pressure turbine of the turbomachine of FIG. 1.

FIG. 3 is a perspective view of a straightener.

FIG. 4 is a perspective view of a movable blade.

FIG. 5 is a flowchart representing the steps of a method for manufacturing a turbomachine blade made of ceramic-matrix composite material.

FIG. 6 represents elements for the implementation of the method of FIG. 5.

FIG. 7 represents an assembly step of the method of FIG. 5.

FIG. 8 is a partial sectional view showing a groove according to one embodiment.

FIG. 9 is a partial sectional view of an assembly according to one embodiment.

FIG. 10 is a partial sectional view of an assembly according to another embodiment.

FIG. 11 is a partial sectional view of an assembly according to another embodiment.

In all the figures, the elements in common are identified by identical numerical references.

### DETAILED DESCRIPTION

In what follows, the elements common to the different embodiments are identified by the same numerical references.

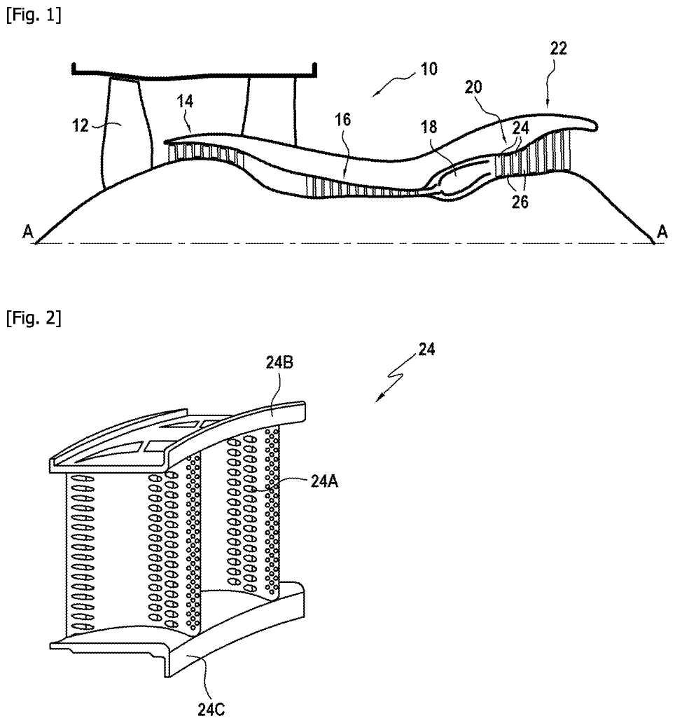

FIG. 1 represents, in section along a vertical plane passing through its main axis A, a turbofan engine 10. The turbofan engine 10 includes, from upstream to downstream according to the circulation of the air stream, a fan 12, a low-pressure compressor 14, a high-pressure compressor 16, a combustion chamber 18, a high-pressure turbine 20, and a low-pressure turbine 22.

The high-pressure turbine 20 comprises a plurality of movable blades 26 rotating with the rotor and of straighteners 24 mounted on the stator.

FIG. 2 represents a straightener portion 24 of a high-pressure turbine 22 of a turbomachine, for example a turbojet engine. The straightener portion 24 comprises, in the example of FIG. 2, two airfoils 24A joined by respectively a platform 24B at the airfoil tip, common to the two airfoils 24A and a platform 24C at the airfoil base, common to the two airfoils 24A.

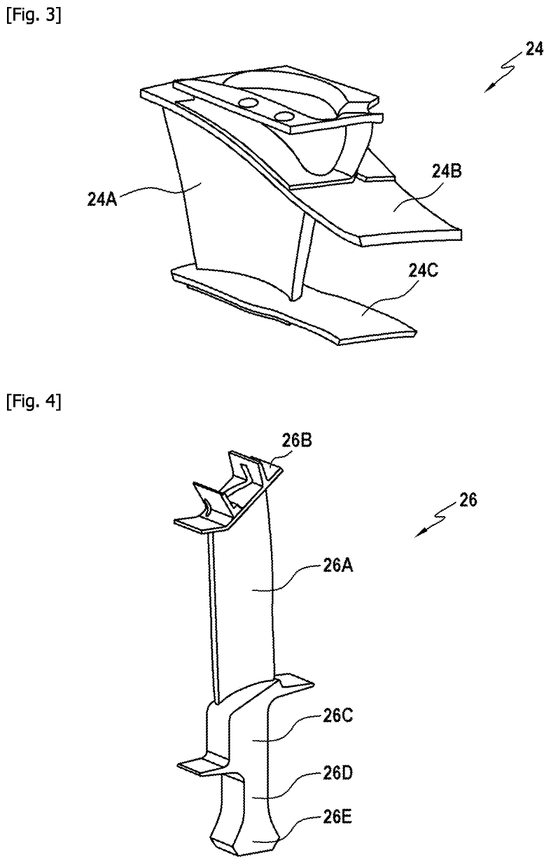

FIG. 3 represents a straightener 24 comprising an airfoil 24A, a platform 24B at the airfoil tip and a platform 24C at the airfoil base.

FIG. 4 represents a movable blade 26 comprising an airfoil 26A, a platform 26B at the airfoil tip and a platform 26C at the airfoil base. As represented in FIG. 3, the platform 26C at the airfoil base is extended by a stilt 26D and a bulb 26E.

The method 100 for manufacturing a turbomachine blade made of ceramic-matrix composite material, particularly the straightener 24 of FIG. 3, will be described with reference to FIGS. 4 to 11.

The method 100 comprises a step 102 of producing a first fibrous preform 28A comprising ceramic fibers, the first fibrous preform 28A forming an airfoil preform.

The method 100 comprises a step 104 of producing a second fibrous preform 28B comprising ceramic fibers, the second fibrous preform 28B comprising a housing 28D, the second fibrous preform 28B forming a platform preform, for example at the airfoil tip.

The method 100 comprises a step 104 of producing a second fibrous preform 28C comprising ceramic fibers, the second fibrous preform 28C comprising a housing 28E, the second fibrous preform 28C forming a platform preform, for example at the airfoil base.

It is understood that the production step 104 may be repeated to form several second fibrous preforms, for example two second fibrous preforms, one forming a platform preform at the airfoil tip and the other forming a platform preform at the airfoil base.

The first fibrous preform 28A may be produced by multilayer weaving of ceramic fibers to form a first fibrous preform 28A in one piece, by superposition of webs of ceramic fibers or by superposition of unidirectional ceramic fibers. It is understood that the webs and the unidirectional ceramic fibers may have a different orientation in each layer.

The second fibrous preform 28B, 28C may be produced by multilayer weaving of ceramic fibers to form a second fibrous preform 28A in one piece, by superposition of webs of ceramic fibers or by superposition of unidirectional ceramic fibers. It is understood that the webs and the unidirectional ceramic fibers may have a different orientation in each layer. The second fibrous preform 28B, 28C may be produced with short fibers.

The steps of multilayer weaving of ceramic fibers may or may not be followed by respective steps of shaping the fibrous preforms.

The multilayer weaving performed may be in particular an “interlock” weave, i.e. a weave in which each layer of weft yarns interlinks a plurality of layers of warp yarns, with all of the yarns in the same weft column having the same movement in the weave plane. Other types of multilayer weaving could be used. Various usable multilayer weaving modes are described in particular in document WO2006/136755.

The weaving may be performed with warp yarns extending in the longitudinal direction of the preforms, it being noted that a weaving with weft yarns in this direction is also possible.

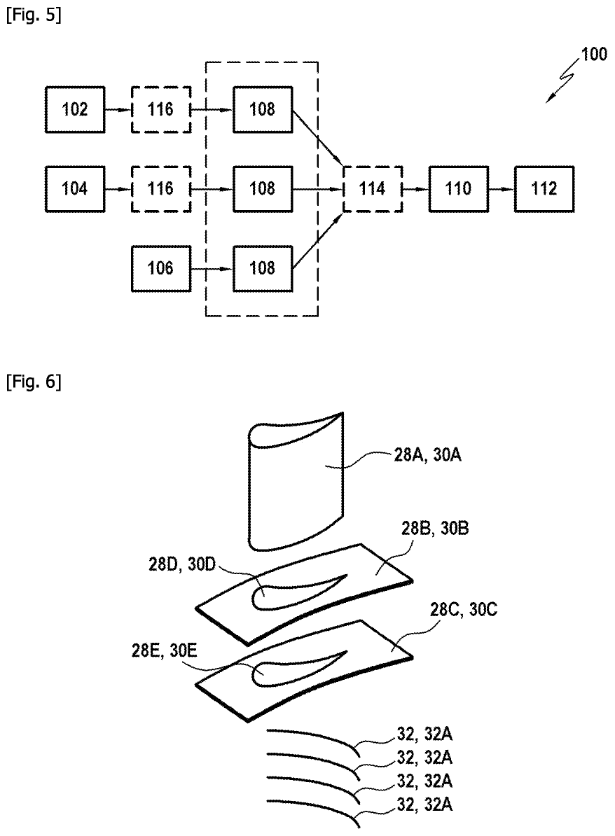

The method 100 comprises a step 106 of producing a strand 32A of ceramic fibers, in the embodiment of FIGS. 5 to 11, four strands 32A of ceramic fibers. The strands of ceramic fibers 32A may for example be obtained with twisted yarns or braided yarns.

FIG. 6 represents the first fibrous preform 28A forming an airfoil preform, the second fibrous preform 28B forming a platform preform at the airfoil tip, the second fibrous preform 28C forming a platform preform at the airfoil base and four strands of ceramic fibers 32A.

The ceramic fibers of the first, of the second fibrous preforms 28A, 28B, 28C and of the strands 32A are for example made of Hi-Nicalon™ Type S.

The method 100 comprises a step 108 of consolidating the first fibrous preform 28A, the second fibrous preforms 28B, 28C and four strands of ceramic fibers 32A to form a first consolidated preform 30A in one piece, two second consolidated preforms 30B, 30C in one piece each each comprising a housing 30D, 30E and four consolidated strands 32, as represented in FIG. 6.

By way of non-limiting example, the consolidated strands 32 may have a diameter of approximately 3 mm.

It is understood that the housing 30D of the second consolidated preform forming a platform preform at the airfoil tip corresponds, after consolidation, to the housing 28D of the second fibrous preform 28D forming a platform preform at the airfoil tip.

Similarly, it is understood that the housing 30E of the second consolidated preform 30C forming a platform preform at the airfoil base corresponds, after consolidation, to the housing 28E of the second fibrous preform 28E forming a platform preform at the airfoil base.

The fibrous preforms 28A, 28B, 28C and the strands 32A of ceramic fibers are consolidated by deposition of a consolidation phase in the porosity of the fibrous preforms 28A, 28B, 28C and the strands 32A of ceramic fibers, this consolidation phase being deposited by gas or liquid process in a manner known per se.

The steps 108 of consolidating the preforms and the strands have been represented as being distinct steps, but the fibrous preforms and the strands may be consolidated during a common consolidation step.

The liquid process consists in impregnating the preform with a liquid composition containing a precursor of the material of the consolidation phase. The precursor usually comes in the form of a polymer, such as a resin, optionally diluted in a solvent. The preform is placed in a mold that may be sealingly closed. Then, the mold is closed and the consolidation phase liquid precursor (for example a resin) is injected into the mold in order to impregnate the preform.

The transformation of the precursor into the consolidation phase is carried out by heat treatment, generally by heating of the mold, after removal of the possible solvent and crosslinking of the polymer.

In the case of the formation of a ceramic material consolidation phase, the heat treatment includes a step of pyrolysis of the precursor to form the ceramic material consolidation phase. By way of example, liquid ceramic precursors, in particular of SiC, may be resins of the polycarbosilane (PCS) or polytitanocarbosilane (PTCS) or polysilazane (PSZ) type. Several consecutive cycles, from the impregnation to the heat treatment, may be carried out to achieve the desired consolidation.

In the gas process (Chemical Vapor Infiltration of the consolidation phase; CVI process), the fibrous preform is placed in a furnace in which a reaction gas phase is admitted. The pressure and the temperature prevailing in the furnace and the composition of the gas phase are chosen so as to allow the diffusion of the gas phase within the porosity of the preform to form therein the consolidation phase by deposition, at the heart of the material in contact with the fibers, of a solid material resulting from a decomposition of a constituent of the gas phase or from a reaction between several constituents. The formation of a SiC consolidation phase may be obtained with methyltrichlorosilane (MTS) giving SiC by decomposition of the MTS.

The first consolidated preform 30A and the second consolidated preforms 30B, 30C may optionally be shaped, for example by machining.

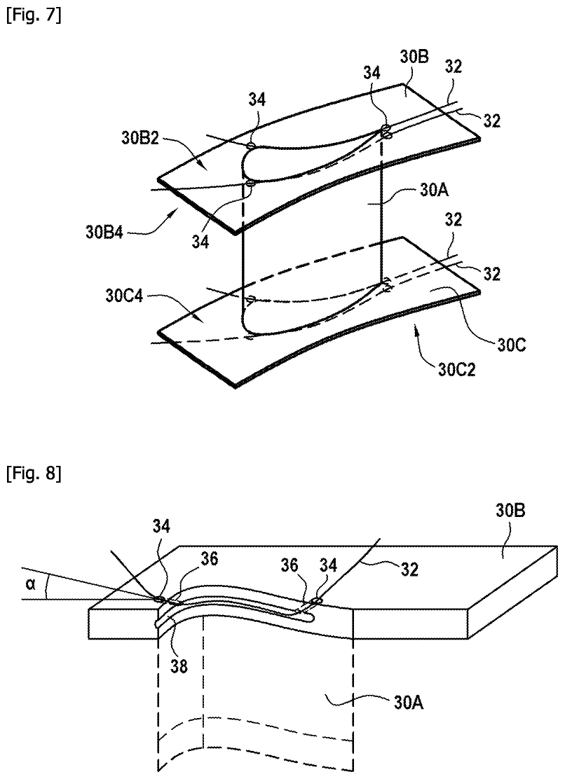

The method 100 comprises a step 110 of assembling the first consolidated preform 30A and the two second consolidated preforms 30B, 30C, by engagement and cooperation of the first consolidated preform 30A, respectively in the housing 30D, 30E of the two second consolidated preforms 30B, 30C, the consolidated strands 32 being interposed between the first consolidated preform 30A and each of the second consolidated preforms 30B, 30C, as represented in FIG. 7.

It is understood that the first consolidated preform 30A is inserted into the housings 30D, 30E of the two second consolidated preforms 30B, 30C.

The method 100 comprises a step of 112 of co-densifying the assembly to form the turbomachine blade, for example the straightener 24 of FIG. 3.

A co-densification of the first and second preforms thus assembled is then carried out.

In one exemplary embodiment, the co-densification may be carried out by a melt infiltration process.

In this method, there is firstly introduction, into the porosity of the first and second assembled preforms, of fillers, for example reactive fillers, the fillers being for example chosen from SiC, Si₃N₄, C, B, and mixtures thereof. The introduction of the fillers may, for example, be performed by slurry cast, by suction of sub-micron powders (APS) or by an injection process of the resin injection molding process (Resin Transfer Molding or RTM) type in which a heat treatment is performed after injection to evaporate the liquid medium.

Once the fillers have been introduced, the first and second preforms are then infiltrated with a melt infiltration composition including, for example, silicon in order to form a matrix and thus obtain the turbomachine blade. The infiltration composition may consist of molten silicon or alternatively be in the form of a molten alloy of silicon and one or more other constituents. The constituent(s) present within the silicon alloy may be chosen from B, Al, Mo, Ti, and mixtures thereof. When reactive fillers are used, substantially all of the reactive fillers may be consumed during the reaction between the infiltration composition and the reactive fillers. As a variant, only part of the reactive fillers is consumed during this reaction.

In one exemplary embodiment, the melt infiltration carried out may make it possible to obtain a matrix by reaction between solid fillers, for example of the type C, SiC or Si₃N₄ introduced by Slurry cast or pre-impregnated, and a silicon-based molten alloy. The reaction may occur at a temperature greater than or equal to 1,420° C. Given the high temperatures implemented, it may be advantageous that at least part of the first and second preforms consists of heat-stable fibers, for example of the Type Hi-Nicalon™ type S.

The yarns of the first and second preforms may, before infiltration of the infiltration composition, have been coated with an interphase layer, for example made of BN or BN doped with silicon, as well as a carbide layer, for example made of SiC and/or Si₃N₄, for example carried out by gas process.

As a variant, it is first of all possible to carry out a first step of co-densifying the first and second preforms assembled by liquid-process densification, this type of process being as described above in relation to the step of consolidating the fibrous preforms. The step may then be followed by a second step of co-densification by chemical vapor infiltration (this type of process being as described above in relation to the step of consolidating the fibrous preforms) or by melt infiltration. The second co-densification step is carried out in order to fill all or part of the residual porosity resulting after implementation of the first co-densification step. A co-densification combining liquid process and gas process makes it possible to advantageously facilitate the implementation, limit the costs and the manufacturing cycles while obtaining satisfactory characteristics for the envisaged use.

Still as a variant, it is first of all possible to carry out a first step of co-densifying the first and second preforms assembled by chemical vapor infiltration. The co-densification step by chemical vapor infiltration may be followed by a shaping step, for example by machining. A second co-densification step may then be carried out by a melt infiltration process.

As represented in FIG. 8, after consolidation 108 of the second consolidated preform 30B forming a platform preform at the airfoil tip, and before assembly 110, a groove 38 may be machined (step 114) in the second consolidated preform 30B. This groove 38 is configured to at least partially receive a consolidated strand 32.

In the embodiment of FIG. 8, the groove 38 is visible from the housing 30D of the second consolidated preform 30B forming a platform preform at the airfoil tip.

In the embodiment of FIG. 8, the second consolidated preform 30B forming a platform preform at the airfoil tip comprises two channels 36 for inserting the consolidated strand 32 into the groove 38. The channels 36 open out onto an outer face 30B2 of the second consolidated preform 30B forming a platform perform at the airfoil tip. The channels 36 form orifices 34 on the outer face 30B2 of the second consolidated preform 30B forming a platform preform of the blade airfoil. The channels 36 may have an angle α relative to the outer face 30B2, the angle α being greater than or equal to 1° and less than or equal to 20°.

It is understood that the second consolidated preform 30B forming a platform preform at the airfoil tip includes an inner face 30B4, opposite to the outer face 30B2 and facing the first consolidated preform 30A. It is understood that the inner face 30B4 partly delimits the aerodynamic flowpath.

In the embodiment of FIGS. 7 and 8, the groove 38 is present in the thickness of the second consolidated preform 30B forming a platform perform at the airfoil tip and the groove 38 is present at least so that a consolidated strand 32 may be interposed between the first consolidated preform 30A and the second consolidated preform 30B forming a platform preform at the airfoil tip, on an intrados side and on an extrados side of the first consolidated preform 30A.

It is understood that a groove may also be machined in the second consolidated preform 30C forming a platform preform at the airfoil base. In a manner similar to what has been described for the second consolidated preform 30B forming a platform preform at the airfoil tip, channels open out onto an outer face 30C2 of the second consolidated preform 30C forming a platform preform at the airfoil base. The channels 36 form orifices 34 on the outer face 30C2 of the second consolidated preform 30C forming a platform preform at the airfoil base. The channels 36 may have an angle α relative to the outer face 30C2, the angle α being greater than or equal to 1° and less than or equal to 20°.

It is understood that the second consolidated preform 30C forming a platform preform at the airfoil base includes an inner face 30C4, opposite to the outer face 30C2 and facing the first consolidated preform 30A. It is understood that the inner face 30C4 partly delimits the aerodynamic flowpath.

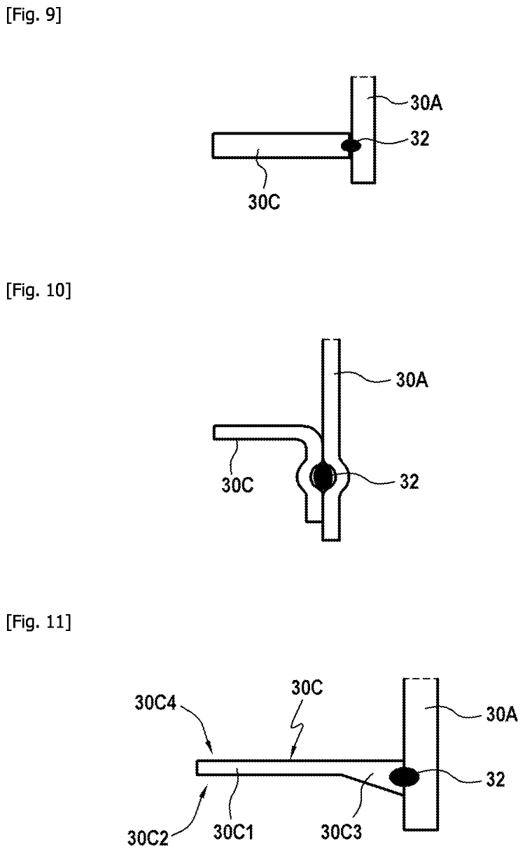

Similarly, the groove 38 may be machined in the first consolidated preform as represented schematically in FIG. 9 for the second consolidated preform forming a platform preform at the airfoil base.

In some embodiments, the groove 38 may be formed during the step of producing the first fibrous preform 28A and the second fibrous preform 28B, 28C, by deformation of the fibrous preforms, during a step 116 of forming the groove 38, as represented in FIG. 10. This step 116 of forming the groove 38 is carried out before the step 108 of consolidating the fibrous preform.

In some embodiments, the second consolidated preform 30C forming a platform preform at the airfoil base may have a part including an extra thickness relative to a part 30C1 of the second consolidated preform 30C, the part including the extra thickness 30C3 delimiting the housing 30D, 30E, as represented in FIG. 11 for the second consolidated preform 30C forming a platform preform at the airfoil base. It will be noted that the thickness is modified on the outer face 30C2 of the second consolidated preform 30C forming a platform preform at the airfoil base in order to disrupt the aerodynamic stream in the flowpath as little as possible.

FIGS. 9 to 11 represent the assembly of the first consolidated preform with the second consolidated preform 30C forming a platform preform at the airfoil base. It is understood that these embodiments may be applied in a similar manner for the assembly of the first consolidated preform 30A with the second consolidated preform 30B forming the platform preform at the airfoil tip.

It is understood that the groove 38 may be machined in a preform and formed in the other consolidated preform with which it is assembled.

It is understood that the formation of the groove 38 may also comprise the formation of the channels 36 in the preform.

The fibrous preform may comprise a groove formed in the fibrous preform and a step of machining the channels 36.

In some embodiments, part of the consolidated strands 32 may be removed before the co-densification step 112.

In some embodiments, part of the consolidated strands 32 may be removed after the co-densification step 112.

By way of non-limiting example, the parts of the consolidated strands 32 which protrude from the outer face 3062, 30C2 of the second consolidated preforms 30C may be kept during the co-densification step 112 to promote the capillary rise of an infiltration liquid during the co-densification step. After co-densification 112, these parts may be removed by machining.

Although the present disclosure has been described with reference to one specific exemplary embodiment, it is obvious that different modifications and changes may be made to these examples without departing from the general scope of the invention as defined by the claims. Furthermore, individual characteristics of the different embodiments discussed may be combined in additional embodiments. Accordingly, the description and drawings should be considered in an illustrative rather than restrictive sense.

1. A method for manufacturing a turbomachine blade made of ceramic-matrix composite material comprising an airfoil and a platform, the method comprising:
the production of a first fibrous preform comprising ceramic fibers, the first fibrous preform forming an airfoil preform;
the production of a second fibrous preform comprising ceramic fibers, the second fibrous preform comprising a housing, the second fibrous preform forming a platform preform;
the production of a strand of ceramic fibers;
the consolidation of the first fibrous preform in one piece, of the second fibrous preform in one piece and of the strand of ceramic fibers to form a first consolidated preform, a second consolidated preform comprising a housing and a consolidated strand;
the assembly of the first consolidated preform and of the second consolidated preform, by engagement and cooperation of the first consolidated preform in the housing, the consolidated strand being interposed between the first consolidated preform and the second consolidated preform;
the co-densification of the assembly to form the turbomachine blade.

2. The method according to claim 1, wherein the consolidated strand is disposed in a groove formed at least in one of the first consolidated preform or of the second consolidated preform.

3. The method according to claim 2, wherein the groove is at least partially machined.

4. The method according to claim 2, wherein the groove is at least partially formed during the step of producing the first fibrous preform and/or the second fibrous preform.

5. The method according to claim 2, wherein the second consolidated preform comprises two channels for inserting the consolidated strand into the groove.

6. The method according to claim 5, wherein the channels open out onto an outer face of the second consolidated preform.

7. The method according to claim 6, wherein the channels have an angle (α) relative to the outer face greater than or equal to 1° and less than or equal to 20°.

8. The method according to claim 1, wherein part of the consolidated strand is removed before the co-consolidation step.

9. The method according to claim 1, wherein part of the consolidated strand is removed after the co-consolidation step.

10. The method according to claim 1, wherein the second consolidated preform comprises a part including an extra thickness, the part including the extra thickness delimiting the housing.

11. The method according to claim 1, wherein the first fibrous preform comprises multilayer woven ceramic fibers, webs of ceramic fibers or unidirectional long ceramic fibers.

12. The method according claim 1, wherein the second fibrous preform comprises multilayer woven ceramic fibers, webs of ceramic fibers, unidirectional long ceramic fibers or short ceramic fibers.
